(19) United States
(12) Patent Application Publication
(10) Pub. No.: US 2024/0118022 A1
(43) Pub. Date: Apr. 11, 2024

(54) Non-Electric Alcohol Fluid Chiller with the Use of Liquid Carbon Dioxide

(71) Applicants: Bert Douglas Montgomery, Houston, TX (US); David Richard Garcia, San Antonio, TX (US); Bruce L. Ludwig, Colleyville, TX (US)

(72) Inventors: Bert Douglas Montgomery, Houston, TX (US); David Richard Garcia, San Antonio, TX (US); Bruce L. Ludwig, Colleyville, TX (US)

(21) Appl. No.: 18/546,208

(22) PCT Filed: Feb. 11, 2022
(86) PCT No.: PCT/US22/70645

§ 371 Date: Aug. 11, 2023

Related U.S. Application Data
(60) Provisional application No. 63/148,233, filed on Feb. 11, 2021.

(51) Int. Cl. F25D 31/00; B67D 3/00

(52) U.S. Cl. CPC F25D 31/003; B67D 3/0009; B67D 2210/00104

(57) ABSTRACT

The present invention relates generally to an apparatus and method of rapidly and efficiently cooling a liquid, wherein flow is induced via gravitational feed from a reservoir, through a cooling chamber, further in connection to a refrigerant source wherein said liquid exits through an inferior actuatable outlet and said refrigerant is released through an exit valve. Specifically, the present invention allows for the rapid cooling of an alcoholic liquid through contactless exposure a carbon dioxide refrigerant source whereby said liquid and refrigerant occupy separate, non-communicating chambers.

### FIELD OF THE INVENTION

The present invention relates generally to an apparatus and means of quickly and efficiently cooling a liquid, inducing fluid flow via gravitational feed from a superiorly disposed reservoir, and cooling via a cooling chamber, itself in connection to a refrigerant source, wherein said liquid exits through an inferior actuatable tap and said gas refrigerant is released through an exit valve from said cooling chamber. Specifically, the present invention allows for the rapid cooling of a liquid through contactless exposure to a carbon dioxide refrigerant source whereby said liquid and refrigerant occupy separate, proximate but non-communicating chambers allowing for rapid cooling without direct contact between refrigerant and liquid.

### BACKGROUND

Consumable alcohol, when mixed with other ingredients or alone, has long been “chilled” to an appropriate temperature that is well below ambient room temperature. And, due to the properties inherent in alcohol, an alcoholic liquid that is at least approximately 32 percent (64 proof) can be applied to otherwise freezing conditions without itself freezing. This rapid decrease in temperature has been historically achieved through the introduction of or comingling of ice with alcohol, as well as other desired ingredients, which are made to come into contact with an appropriate measure of ice and either served with the ice, or strained, wherein the liquid, once cooled, is segregated from the ice and served “straight” or “straight up” (often confused with “neat” or without ice or chilling) or as a chilled “shot”. Alternatively, alcoholic spirits may be chilled using customary vapor-compression refrigeration systems of refrigeration requiring both (1) electrical power generation and (2) use of environmentally detrimental gases (e.g., freon).

The development and mass production of a myriad of alcoholic beverages has undergone many augmentations and modifications over centuries (and even millennia) wherein a whole host of liquors have been developed across the spectrum of distilled spirits, utilizing various and varied distilling, storing and dispensing techniques. Yet, the means in which to quickly and efficiently lower the temperature of a consumable liquor beverage has, to date, undergone little change and continues to require electrically dependent refrigeration.

Demonstrably, the chilling of liquors, at some point in the process, requires reliance upon conventional refrigeration—through the direct use of refrigeration or the indirect use of the product of refrigeration—ice. This dependence upon refrigeration invites a downstream reliance upon both externally derived electricity and refrigerants including potentially hazardous chlorofluorocarbons (CFCs), hydrochlorofluorocarbons (HCFCs), hydrofluorocarbons (HFCs) and commonly freons or halocarbons that are synthetically produced.

Regardless of refrigerant choice, though, all refrigerants consist of elements in a liquid or gas form that are utilized to capture heat from one area and release that heat into another area (i.e., a heat sink). Therefore, refrigeration itself may be best viewed as the sequestration of or removal of heat more than a supplanting of cool for heat. Refrigerants in refrigerating systems (e.g., air conditioners, refrigerators and freezers) utilize primarily a rapid liquid to gas thermodynamic phase change and subsequent heat release. During this thermodynamic phase change, refrigerants ultimately display a cycle of liquid converting to gas and gas into a liquid. Succinctly, refrigerant starts in an evaporator component of the system wherein the refrigerant liquid absorbs heat and subsequently changes to vapor (gas) under low pressure. It is this integral point in the refrigeration process where a liquid traverses a throttle or expansion valve wherein pressure rapidly goes from high pressure to low pressure and “spot” or “flash” refrigeration. The compressor pressure and temperature subsequently increase whereby the release of heat from the vapor happens in the condenser component of the system. The refrigerant then changes back to liquid form as it travels back to the evaporator and the process is repeated again and again, recycling the refrigerant over and over.

Yet, this system, in spite of its utility, relies on the use of a multitude of environmentally harmful refrigerants which harbor both Ozone Depletion Potential (ODP) and Global Warming Potential (GWP)—CFCs having possibly the largest ODP and GWP due to their chlorine content. Although, the refrigerant itself is recirculated, small amounts of ozone deleting refrigerants ultimately escape and are released in the atmosphere. Here these CFC-based refrigerants enter the atmosphere and are subsequently disintegrated. This disintegration releases chlorine which interacts with ultraviolet (UV) absorbing ozone (0₃) in the upper atmosphere, the detrimental CFC released chlorine exhibiting an exceptionally long atmospheric life (on the order of 100 plus years) having the effect of converting ozone (0₃) into oxygen (0₂), which does not share the same filtering properties. UV light is thus allowed to enter through to the earth's lower atmosphere, most pointedly at the earth's poles, and directly cause heat to accumulate at the earth's poles. Additionally, loss of Oxone in the atmosphere disallows heat escape through IR heat loss from the earth's surface and further exacerbates temperature increases globally. Subsequent heat accumulation causes glacial retreat, increased flooding, weather extremes, as well as other climate disruptions leading to a myriad of untoward ecological effects.

Conversely, inorganic, naturally occurring refrigerants (i.e., carbon dioxide and ammonia) have small ODPs (Ozone Depleting potential) and GWPs (Global Warming Potential) and constitute an ecologically preferable refrigerant for most uses. Yet, even though ammonia has an ODP and GWP of zero, it also has a marked potential as a human toxic agent as well as an odor that may be off-putting. CO2, conversely, has a much smaller potential for toxicity and no odor (although it has a GWP of 1). Moreover, CO2 plays an integral role in photosynthesis and plant respiration, constituting an integral component resulting in oxygen and water release.

As currently presented, the apparatus and means of quickly and efficiently cooling a liquid does not rely on recirculation of refrigerant, but rather a cooling and exhausting wherein CO2 is released after use. This release is proportionately negligible as related to brewers offgassing or use as cannabis indoor growing supplementation. Yet, inventors contemplate, as technology progresses, that carbon sequestration may become a viable option for recirculation and recycling.

By addressing the untenable tethering to electrical power and CFC refrigerants, use of alternative refrigerants (i.e., CO2) seeks to maximize the benefits of a cooling system utilizing no electrical input, reducing power requirements and easing location constraints with an environmentally friendly and highly portable refrigerant. Indeed, the present apparatus, system and method of use addresses the above cited shortcomings and exceeds in advancing a user-friendly, mobile and environmentally conscious means of cooling via refrigerants. This is especially important noting that the refrigerant utilized in the present invention, CO2, makes up only 0.04% of the atmosphere and that this same gas is consumed in photosynthesis and plant respiration to produce sugar and starches from CO2 and water.

Explicitly, the present invention relies upon a cooling chamber which receives high pressure liquid CO2, injected into a receiving chamber, through high pressure liquid CO2 inlets (exhibiting an expansion valve), which turns CO2 liquid into a CO2 gas vapor. The gaseous phase of CO2 is then introduced into an encapsulated area (as a CO2 gas) whereby the CO2 circulates around and within a (1) centrally disposed and/or (2) concentrically positioned alcohol (alcoholic beverage inlet “gravity feed” channels). The alcohol and/or alcoholic beverage inlet “gravity feed” thus allows for exposure of the alcohol indirectly to the refrigerant through (1) internal temperature exchange via a centrally deposed lumen and/or (2) via concentrically positioned channels existing around central channels (as well segregated from the refrigerant) whereby the CO2 gas runs contiguously with inserted alcohol but does not contact the alcohol or comingle with the alcohol. The configuration is such that the alcohol is allowed access to areas above, around and below internalized CO2 gas channels (whereby the liquid is bathed in close connection with the refrigerant) without coming into direct contact with the CO2 itself. The CO2 is then expelled via exit valves and the alcohol is allowed to travel through the cooling chamber and through an outlet for dispensation with temperature being exchanged but no contact between alcohol and gaseous CO2. Yet, it is within the contemplation of inventors to adjust the configuration of the internalized CO2 and/or alcohol chambers as to allow for maximum alcohol exposure with minimum CO2 gas administration requirements where one to a plurality of chambers may exist for both liquid and gas.

Currently, inventors submit, is the second phase of the ‘revolution in refrigeration’ wherein the remediation of certain inadequacies and deficiencies may be addressed by the current invention to maximize the beneficial effects of refrigeration while rejecting the environmentally detrimental consequences of refrigerant use. And while it is undisputed that refrigeration is highly desirable and valued in today's society, it remains untenable how said refrigeration is customarily supplied, and the negative externalities such refrigeration continues to present. Truly, (a) electricity free refrigerant supply via (b) inert refrigerants, taken individually, will effectively usher in a complete change in the paradigm of delivering location-independent refrigerant to power-dependent areas. Yet, taken together, this combination, most certainly effectively ensures the greatest likelihood of the success of such a shift toward increased accessibility and decreased environmental “carbon footprinting” in terms of refrigerants and power consumption alike.

To this end, it is the present invention that will create and maintain a new means to refrigerate liquids independent of external energy sources or destructive gases.

Thus, there is a significant and well recognized, and yet unmet, need in the art for a refrigerant supply, in the form of a carbon dioxide-based refrigerant, that provides a location and power independent mechanism for delivery. The present invention satisfies this long-standing need in the art to address the above enumerated infirmities in the field.

### BRIEF SUMMARY OF THE INVENTION

The present disclosure provides a novel, mechanically tested and ecologically friendly apparatus, system and method of applying inert refrigerant, indirectly, to an alcoholic liquid to support more palatable consumer consumption of alcohol in an more environmentally conscious manner.

It is therefore the stated goal of the present invention to deliver a combination of (1) rapid and efficient cooling in (2) an electrically and location independent system that (3) is both compact and highly mobile and (4) involves the use of a largely non-volatile, inert refrigerant or refrigerants.

Succinctly, the current invention provides for rapid, efficient, ergonomic, highly mobile and environmentally conscious means of lowering the temperature of a liquid absent the need for generated electrical power or harmful refrigerants. Manifestly, it is this rapid cooling and use of ozone-safe refrigerant, absence of reliance upon electricity, that offers both immediate and long term benefits

### BRIEF DESCRIPTION OF THE DRAWINGS

While the novel features and method of use of the application are set forth above, the application itself, as well as a preferred mode of use, and advantages thereof, will best be understood by referencing to the following detailed description when read in conjunction with the accompanying drawings in view of the appended claims, wherein:

FIG. 1 shows a schematic of the present invention and system for a CO2 supplied refrigeration system.

FIG. 2 depicts the cooling chamber of FIG. 1.

FIG. 3 illustrates a simplified cooling and dispensing chamber.

FIG. 4 is a front and left side profile view of the present invention.

FIG. 5 shows front and right-side profile view of a preferred embodiment of the resent invention.

And while the present invention, system and method of use are amendable to various modifications and alternative configurations, specific embodiments thereof have been shown by way of example in the drawings and are herein described in adequate detail to teach those having skill in the art how to make and practice same. It should, however, be understood that the above description and preferred embodiments disclosed, are not intended to limit the invention to the particular embodiment disclosed, but on the contrary, the invention disclosure is intended to cover all modifications, alternatives and equivalents falling within the spirit and scope of the invention as defined within the claim's broadest reasonable interpretation consistent with the specification.

### DETAILED DESCRIPTION OF THE INVENTION

While advantages of the present invention will be readily apparent to those having skill in the art based on the appended description, there are described certain embodiments constituting the present invention and examples for illustrative purposes. And, although the following detailed description contains specific references to mechanical parts and configurations, one having skill in the art will certainly appreciate that modifications, alterations and variations are within the scope of the present invention. Accordingly, the following embodiments of the invention are set forth without any loss of generality to, and without imposing limitations upon, the claimed invention. While preferred embodiments are described in connection with the description below, there is no intent to limit the scope to the embodiments disclosed below. On the contrary, the intent is to cover all equivalents.

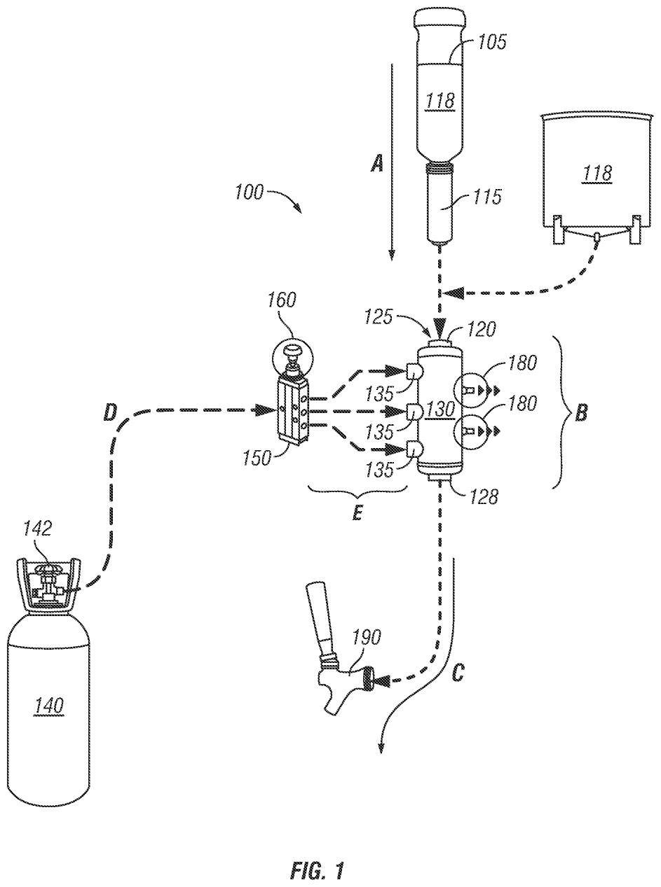

As provided in FIG. 1, the present invention 100 provides for communication of an alcohol or alcoholic beverage bottle or reservoir 110, connected via a receptacle conduit 115 (which may be customized to various sized receptacle conduits 118), and into the superior portion 120 of cooling chamber 130 by facilitating introduction of liquid 105 through inlet 125 acting as a conduit and primary vessel for liquid chilling by cooling chamber 130 whereby liquid CO2 tank 140 is connected to said cooling chamber 130 through a high pressure peak valve conduit 150 for CO2 direction to liquid to gas phase conversion. Peak valve conduit 150 is actuatable through the use of a spring loaded or an otherwise operable valve 160 and is further used for CO2 dispensing and regulation. The cooling chamber 130, additionally, exhibits an expansion valve for phase conversion and an exhaust port or ports 180 for the expulsion of the CO2 gas, post-CO2 liquid-to-gas conversion, and post coolant utilization. The cooling chamber additionally evidences a beverage tap 190, attached to the inferior portion/cooling chamber exit 128 of cooling chamber 130, allowing for the initiation A of un-chilled liquid into the invention, flow B through the invention and egress C out of the invention which is now “chilled” liquid.

Operationally, a valve 142 on the CO₂ tank 140 is turned to the ‘open’ position whereby a conduit exists connecting CO₂ tank 140 to cooling chamber 130, said conduit being a high-pressure peak valve 150, via pathway D and E, respectively, for facilitation of release of liquid CO₂ from the tank CO₂ 140, through an actuatable high pressure peak valve 150, and into said cooling chamber 130. The high-pressure peak valve (having a spring-loaded release valve) acts as a “switching station” whereby depression of the spring-loaded actuation button 160 allows for the conveyance and regulation of the pressurized liquid CO₂ through said high pressure peak valve 150 and into said cooling chamber, through an expansion valve (throttle) following the movement of high pressure (C0₂ tank) to low pressure, through cooling chamber 130 and finally through exists 180. The cooling chamber 130 receives the liquid CO₂ and, through greatly decreased diameters of an outlet or outlets (i.e., expansion valve), causes the liquid CO₂ to move from a high pressure (CO₂ tank 140) area to a low pressure (cooling chamber 130), through said expansion valve, thus converting liquid CO₂ to an aerosolized CO₂ gas through evaporation and cooling the low-pressure cooling chamber 130 area. Being inert, the CO₂, once utilized for freezing said liquid, is then expelled (via exits 180) from the cooling chamber 130. It is also important to note that the cooling chamber 130 itself, while receiving the cooling liquid CO₂ (and transforming it into a gas), does not allow for contact between the introduced CO₂ and introduced alcohol both travelling through the chamber, albeit via different channels. What is more, it is within the contemplation of inventors that carbon capture, now in its nascent stage, may provide a viable pathway for a more ecological use of CO2 going forward.

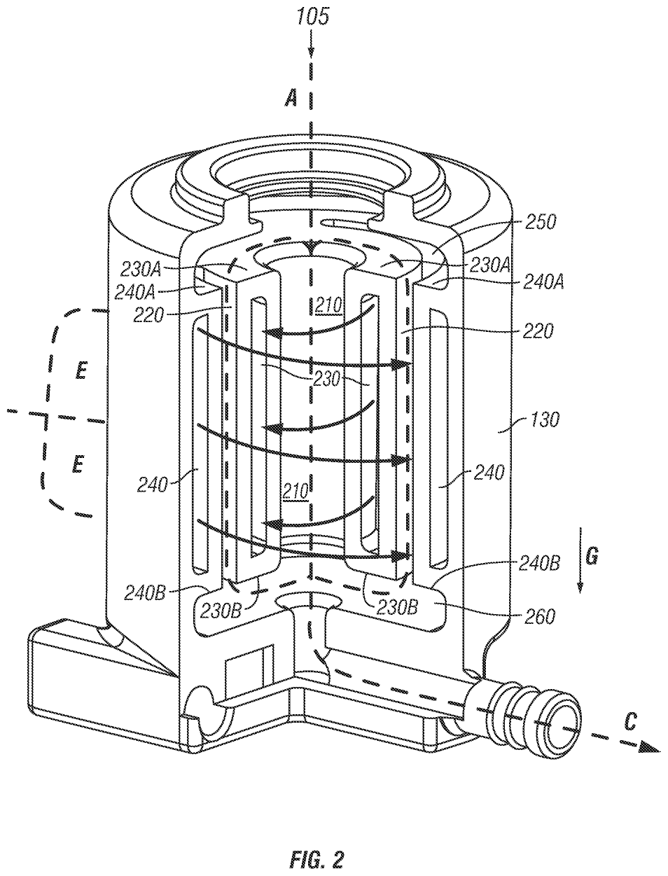

FIG. 2 depicts the pathway taken by liquid 105 (e.g., alcohol), relying on the gravitational pull (g) for introduction into the cooling chamber 130 and through cooling chamber 130 which is nonetheless centrally deposed, correspondingly concentrically disposed chambers 220, or a combination thereof, within the cooling chamber 130 while the CO2 is directed (1) about the inner (primary) CO2 circumferential chamber 230 (about centrally deposed hollow chamber 210) of cooling chamber 130. Moreover, an auxiliary, outward chamber 240 (here secondary CO₂ chamber or chambers 240) exists and “runs” around the more centrally deposed CO₂ chamber 230, in close proximity to the centrally deposed (hollow) center 210, as to increase the surface area and contactable space that the (alcoholic) liquid may encounter. What is more, any number (n) of chambers (C) may be utilized within the cooling chamber (C(n)), which may run concentrically away from the centrally deposed hollow lumen 210 as to provide maximum surface area exposure to inserted alcohol. In what may be envisioned as a ‘dual lumen’, the exemplary model said CO₂ takes a guided path around the cooler-captured liquid (alcohol) and through the chamber's exhaust ports with no comingling of substances. Functionally, the liquid alcohol's path is guided by gravitational pull from the superiorly positioned bottle 110, thorough the cooling chamber 130, along a dedicated path, and ultimately through release via an actuated tap 190. As depicted in FIGS. 1-2, CO₂ enters through an inlet valve or valves 135, moves through a “throttle” (i.e., expansion valve) and circulates into chambers 230 and 240 subsequently releasing through exit valves 180. Contemporaneously, liquid enters through inlet 125, pooling initially in an upper chamber 250, travelling through central chamber 210 and chamber 220 due to gravity and areas of high to low pressure, liquids again pool, now in a second chamber 260 before exiting either laterally (FIG. 1) or horizontally (FIG. 2). Logistically, liquid cools as it pools (superiorly and inferiorly through upper chamber 250, and lower chamber 260, moves centrally via hollow lumen 210 and laterally through contiguous chambers between gas cooled chambers 230, 240. Specifically, the interior gas chamber 230 cools the central lumen 210 and channel 220 simultaneously and from each side of gas chamber 230. Liquid channel 220 is cooled by both gas chamber 230 sides and gas channel 240 sides whereas further cooling occurs both superior (230A, 240A) and inferior (230B, 240B) to gas cooling chambers prior to exit 128.

It should be noted that the superiorly positioned bottle which is attached to the cooling chamber 130 by said inlet of the above description may be replaced by a larger alcohol or alcoholic beverage reservoir 118 which may have a larger capacity for retaining a liquid or liquids.

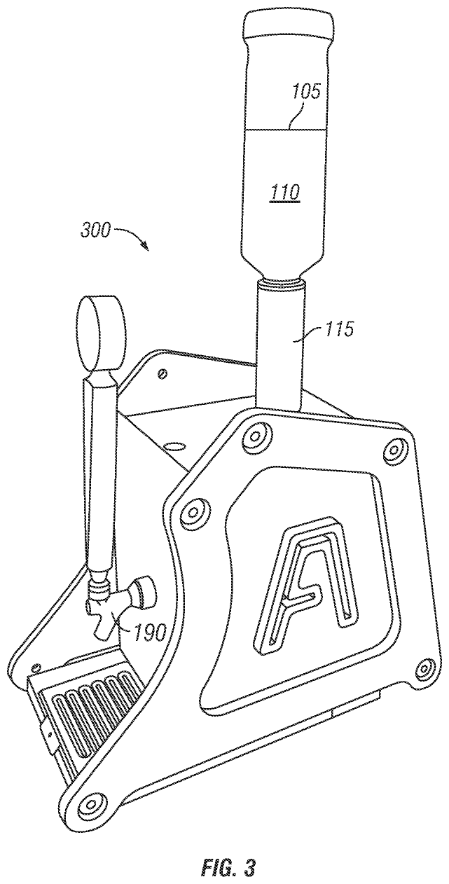

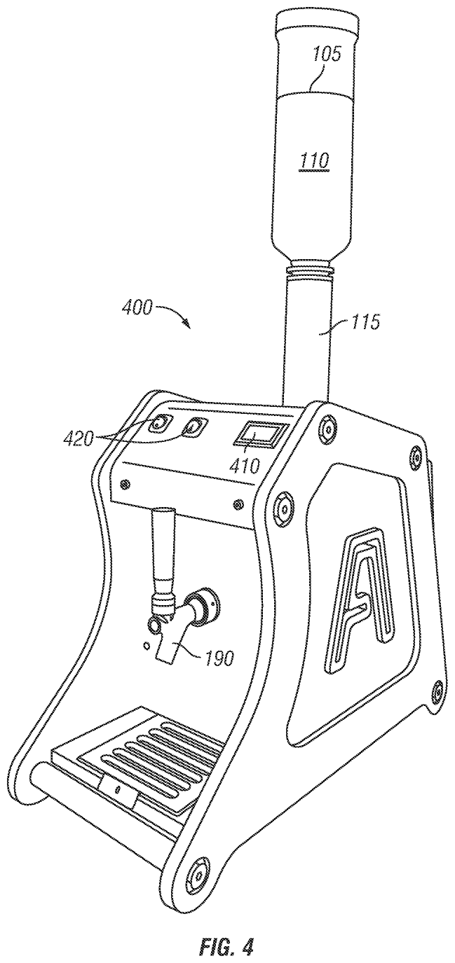

FIGS. 3 and 4 are exteriors of an operable liquor chilling device which may be modified into an operable apparatus with additional features allowing for temperature monitoring 410 and binary switching 420 for integrated operation.

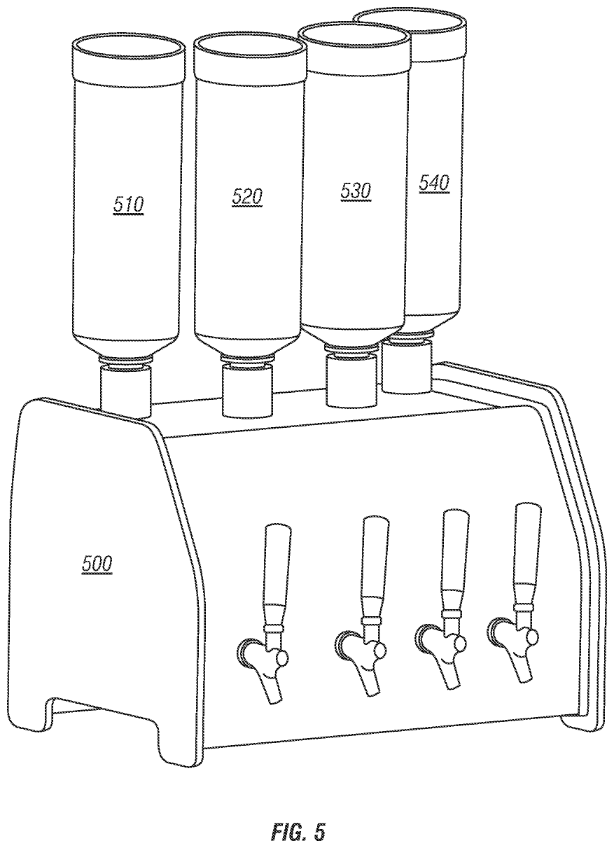

FIG. 5 is a functional embodiment of an expanded version depicting a apparatus capable of exhibiting and cooling 4 individual liquors (510, 520, 530 and 540) with 4 different flavors or liquor types in a single cooling unit 500.

### Preferred Embodiments

In one preferred embodiment, the present invention consists of an apparatus for chilling a single alcohol containing beverage or a single spirit.

In another embodiment, the present invention consists of an apparatus for chilling multiple alcohol containing beverages or a multiple spirits.

In another preferred embodiment, the present invention may be utilized to chill a non-alcoholic beverage, up to an including potable liquids including carbonated waters, non-carbonated waters, teas, coffees, smoothies, milk, juices and the like, albeit at higher temperatures than the alcohol.

In another embodiment, the present invention may be used for liquids intended to be mixed with alcohol typically, and appropriately, named “mixers” up to and including the above.

In yet another embodiment certain non-alcoholic liquids may be introduced inferior to said cooling chamber to be added to said liquid after cooling but prior to dispensing.

In another embodiment, the present invention may be utilized to chill a combination of alcoholic and nonalcoholic beverages that may be (1) premixed or (2) connected to the cooling chamber via separate or conjoined inlets (as described above).

In another embodiment, the present invention may be modified to chill and dispense ice creams or yogurts, flash frozen desserts and the like.

In one preferred embodiment, the present invention consists of a superiorly attached reservoir whereby quantities larger than those that are commercially available are able to be supplied into the cooling chamber and through the tap.

In another embodiment, the present invention may be expanded to include a primary or secondary inlet/out system for the chilling drinkware (e.g., beer mugs or wine glasses) at a patron's table, at a picnic, on a patio, concert, event, from a street vendor and the like via a CO2 injection or a separate holding container specific for drinkware.

In another embodiment, the present invention may be transported to various locations that are precluded from using the present invention due to electrical necessity and location constraints including, but not limited to, backyards, pools, golf courses, recreation areas, picnics, campgrounds, fairs, festivals, concerts, expos, venues, tradeshows, zoos, street vending, cabanas, beaches, resorts, boats, party-barges, ships, recreational flotillas and the like.

In yet another embodiment, the present invention may be transported to various areas about a bar or restaurant (e.g., into corners, on various building levels and sites, around bars or directly to patron's tables) as to provide moveable, positionable and entirely mobile chilled liquids—without the need for electricity.

In another embodiment, the present invention may be located at shows, parks, concerts and the like without regard to electrical access.

In another embodiment, the present invention may be utilized by street vendors or displayed in front of restaurant exteriors without regard to electrical outlet access.

In yet another embodiment, the present invention may be fitted with any of various sized CO2 tanks.

In yet another embodiment, the present invention may use another inert refrigerant (e.g., ammonia) for refrigeration.

In an embodiment, the exterior of the invention may be fitted with or decaled with various signage, logos, insignias, trademarks, signs, dispensaries, brewers names, distillers names and the like.

In yet another embodiment, the exterior may be fitted with signage through the integration of a light battery and exterior illumination system whereby the invention may be modified to display brand signage of a specific liquor brand being dispensed.

And while the subject matter disclosed herein has been described by way of example and in terms of the specific preferred embodiments, it is to be understood that the claimed embodiments are not limited to the specifically disclosed embodiments enumerated herein. To the contrary, the disclosure is intended to cover various modifications, alterations and similar arrangements as are apparent to those skilled in the art. Therefore, the scope of the appended claims are to be accorded the broadest interpretation so as to encompass all such modifications, alterations and similar arrangements. Too, it is to be understood that the above described is intended to be illustrative, and not restrictive. Many other embodiments will be apparent to those of skill in the art upon reading and understanding the above description and will inform the practice and use of same. The scope of the disclosed subject matter is therefore to be determined in reference to the appended claims, along with the full scope of equivalents to which such claims are entitled, in light of the specification.

1. An apparatus for cooling a liquid comprising:
a liquid reservoir;
said liquid reservoir residing superior to a cooling chamber;
said liquid reservoir containing a liquid;
said cooling chamber comprising a first liquid chamber and a second gas chamber;
said first liquid chamber runs contiguously with said second gas chamber;
said first liquid chamber and said second gas chamber remaining separate;
said first liquid chamber comprised of two liquid sub-chambers;
said first liquid sub-chamber centrally disposed and said second liquid sub-chamber separated spatially from said first liquid sub-chamber;
said second liquid sub chamber concentrically disposed about said first sub-chamber;
said second gas chamber comprised of two concentric sub-chambers;
said first concentric gas sub-chamber separating said first centrally disposed liquid sub chamber from said second concentric liquid sub chamber;
said second concentric gas sub-chamber forming the outer perimeter of all inner chambers;
said cooling chamber having an internal superior liquid reservoir above said liquid and gas chambers and an internal inferior liquid reservoir below said liquid and gas chambers;
said superior liquid reservoir disbursing said liquid above said liquid and gas sub-chambers and into said liquid sub chambers;
said inferior liquid reservoir reunifying said liquid;
said cooling chamber having a high pressure liquid CO2 inlet, an expansion valve and a gas CO2 outlet;
a cooled liquid outlet below said cooling chamber; and
a liquid CO2 source.

2. The apparatus of claim 1 wherein said liquid contains alcohol.

3. The apparatus of claim 2 wherein said alcohol is above 64 proof.

4. The apparatus of claim 1 where said cooling chamber may exhibit two to a plurality of liquid chambers and gas chambers for cooling of liquid.

5. The apparatus of claim 1 where said CO2 source is connected to a high-pressure peak valve for CO2 actuation, dispensing and regulation.

6. The apparatus of claim 1 wherein said liquid outlet may be horizontal, perpendicular or both.

7. The apparatus of claim 3 wherein said cooled alcohol liquid outlet may be accompanied by a second outlet for non-alcoholic beverages.

8. The apparatus of claim 1 wherein said cooling chamber may be used for non-alcoholic liquids.

9. The method of rapidly and efficiently cooling a liquid, comprising the steps of:
placing a liquid reservoir superior to a cooling chamber;
placing liquid in said cooling chamber;
providing a cooling chamber;
said cooling chamber having gas chambers and liquid chambers made to run contiguously but separately;
providing a pressurized, liquid refrigerant source to supply refrigerant to said cooling chamber;
causing rapid cooling within said cooling chamber with the introduction of said liquid refrigerant, through narrow diameter nozzles causing said liquid refrigerant to become a gas, and into gas chambers within said cooling chamber;
inducing, via gravitational or gravimetric feed, liquid flow through a centrally deposed chamber, concentrically deposed chambers, or a combination thereof, within said cooling chamber, simultaneous with refrigerant introduction into said cooling chamber;
causing said coolant chambers to be separated and distinct from said liquid chamber to deny liquid and coolant comingling;
releasing said cooled liquid through an inferior outlet; and
releasing said refrigerant through exit valves.

10. The method of claim 9 wherein said refrigerant is CO2.

11. The method of claim 10 wherein there exists a high-pressure peak valve to actuate, release, and regulate CO2 release.

12. The method of claim 9 wherein said liquid contains alcohol.

13. The method of claim 9 wherein said alcohol content is above 64 proof.

14. The method of claim 9 wherein said gas chambers and said liquid chambers may exhibit two to a plurality of sub chambers.

15. The method of claim 9 wherein a second non-alcoholic liquid is introduced inferior to said exit valves for introduction of a non-alcoholic liquid concomitantly with chilled alcoholic liquid.
